(19) United States
(12) Patent Application Publication
(10) Pub. No.: US 2025/0182446 A1
(43) Pub. Date: Jun. 5, 2025

(54) ROBUSTNESS VERIFICATION DEVICE, ROBUSTNESS VERIFICATION METHOD, AND RECORDING MEDIUM

(71) Applicants: NEC CORPORATION, Tokyo (JP); UNIVERSITY OF TSUKUBA, Tsukuba-shi (JP)

(72) Inventors: Kazuya KAKIZAKI, Tokyo (JP); Kazuto FUKUCHI, Tsukuba-shi (JP); Jun SAKUMA, Tsukuba-shi (JP)

(73) Assignees: NEC CORPORATION, Tokyo (JP); UNIVERSITY OF TSUKUBA, Tsukuba-shi (JP)

(21) Appl. No.: 18/842,280

(22) PCT Filed: Mar. 4, 2022
(86) PCT No.: PCT/JP2022/009573

§ 371 Date: Aug. 28, 2024

(51) Int. Cl. G06V 10/74; G06V 10/44

(52) U.S. Cl. CPC G06V 10/761; G06V 10/44

(57) ABSTRACT

A robustness verification device uses the similarity between feature amounts obtained by extracting a feature amount to identify a similar image having a predetermined rank of similarity with respect to an input image within a candidate image group; counts the rank of the similar image with respect to the input image in the candidate image group in a case where adversarial perturbation is applied to the image; calculates the rank of the similar image with respect to the input image in the candidate image group in a case where adversarial perturbation is not applied to the image; and a verifies whether or not the counted rank of the similar image counted is within a predetermined range that includes the calculated rank of the similar.

### TECHNICAL FIELD

This invention relates to a robustness verification device, a robustness verification method, and a recording medium.

### BACKGROUND ART

Adversarial training (AX) has been proposed as a countermeasure against attacks using adversarial examples. Adversarial training is the practice of learning by including adversarial examples in the training data in a case where learning a feature amount extraction model. By using a feature amount extraction model that has undergone adversarial training, it is expected that the output results are less likely to be affected by the input of adversarial examples.

For example, Non Patent Document 1 shows experimentally that adversarial training is effective against attacks on content-based image retrieval using adversarial examples.

### PRIOR ART DOCUMENTS

### Non Patent Document

Non Patent Document 1: Mo Zhou, et al. “Adversarial Ranking Attack and Defense,” The 2020 European Conference on Computer Vision (ECCV 2020), 2020.

### SUMMARY OF THE INVENTION

### Problems to be Solved by the Invention

Non Patent Document 1 shows Adversarial training that depends on the attack method in a case where the attack method is known, such as how the adversarial examples are generated.

On the other hand, there may be unknown attack methods against content-based image retrieval using adversarial examples, which should be addressed. It should be possible to verify the degree of impact on search results given an adversarial example and to ascertain the impact in a case where the attack method is unknown.

An example of an object of the present invention is to provide a robustness verification device, a robustness verification method, and a recording medium that can solve the above-mentioned problems.

### Means for Solving the Problem

According to the first example aspect of the present invention, a robustness verification device includes: a similar image identification means that uses the similarity between feature amounts obtained by a feature amount extractor to identify a similar image having a predetermined rank of similarity with respect to an input image within a candidate image group; a rank counting means that counts the rank of the similar image with respect to the input image in the candidate image group in a case where adversarial perturbation is applied to the image; a rank calculation means that calculates the rank of the similar image with respect to the input image in the candidate image group in a case where adversarial perturbation is not applied to the image; and a rank verification means that verifies whether or not the rank of the similar image counted by the rank counting means is within a predetermined range that includes the rank of the similar image calculated by the rank calculation means.

According to the second example aspect of the present invention, a robustness verification method includes: a step that uses the similarity between feature amounts obtained by a feature amount extractor to identify a similar image having a predetermined rank of similarity with respect to an input image within a candidate image group; a step that counts the rank of the similar image with respect to the input image in the candidate image group in a case where adversarial perturbation is applied to the image; a step that calculates the rank of the similar image with respect to the input image in the candidate image group in a case where adversarial perturbation is not applied to the image; and a step that verifies whether or not the rank of the similar image counted in a case where adversarial perturbation is applied to an image is within a predetermined range that includes the rank of the similar image calculated in a case where adversarial perturbation is not applied to an image.

According to the third example aspect of the present invention, a recording medium records a program for causing a computer to execute: a step that uses the similarity between feature amounts obtained by a feature amount extractor to identify a similar image having a predetermined rank of similarity with respect to an input image within a candidate image group; a step that counts the rank of the similar image with respect to the input image in the candidate image group in a case where adversarial perturbation is applied to the image; a step that calculates the rank of the similar image with respect to the input image in the candidate image group in a case where adversarial perturbation is not applied to the image; and a step that verifies whether or not the rank of the similar image counted in a case where adversarial perturbation is applied to an image is within a predetermined range that includes the rank of the similar image calculated in a case where adversarial perturbation is not applied to an image.

### Effect of Inventions

According to the robustness verification device, robustness verification method, and recording medium described above, it is possible to verify the degree of influence on search results in content-based image retrieval in a case where an adversarial example with adversarial perturbation is applied.

### BRIEF DESCRIPTION OF THE DRAWINGS

FIG. 1 is a schematic block diagram showing an example of the functional configuration of a content-based image retrieval device 900.

FIG. 2 is a drawing showing the range of image x+δ, where noise δ with a radius of ε or less is applied to image x in the infinity norm L_{∞}.

FIG. 3 is a drawing showing a specific example of (α, β)-robustness verification.

FIG. 4 is a schematic block diagram showing an example of the functional configuration of the robustness verification device according to the first example embodiment.

FIG. 5 is a flowchart showing an example of the processing procedure of the robustness verification device according to the first example embodiment.

FIG. 6 is a schematic block diagram showing an example of the functional configuration of the robustness verification device according to the second example embodiment.

FIG. 7 is a flowchart showing an example of the processing procedure of the robustness verification device according to the second example embodiment.

FIG. 8 is a schematic block diagram showing an example of the functional configuration of the robustness verification device according to the third example embodiment.

FIG. 9 is a flowchart showing an example of the processing procedure of the robustness verification method according to the fourth example embodiment.

FIG. 10 is a schematic block diagram showing the configuration of a computer according to at least one example embodiment.

### EXAMPLE EMBODIMENT

The following describes example embodiments of the present invention, but these example embodiments are not intended to limit the invention as claimed. Not all of the combinations of features described in the example embodiments are essential to the solution of the invention.

### [Content-Based Image Retrieval Device 900]

First, an example of a content-based image retrieval device 900 that is subject to robustness verification by a robustness verification device 100 (200) shall be described.

In the real world, content-based image retrieval (CBIR) is used in medical image retrieval systems, similar product retrieval systems, facial recognition systems, and others. Content-based image retrieval is a system that, given an input image q∈χ as a search query, finds an image cᵢ∈C that is highly similar to q from a set of candidate images C={cᵢ∈χ}(i=1 to N). Here, χ represents the input space of images.

In content-based image retrieval, a feature amount extraction model f is used, which is learned by a machine learning model such as Deep Metric Learning (DML), for example. For example, a feature amount extraction model f is a function f·χ→Rⁿ from the input space of images to the n-dimensional vector space of real numbers representing feature amounts. Deep Metric Learning learns the feature amount extraction function f so that feature amounts can be computed such that the distance between images with high similarity is close and the distance between images with low similarity is far.

Content-based image retrieval outputs results based on the Euclidean distance dist(f(q), f(c)) of features amounts between the input image q and any candidate image c∈C. For example, content-based image retrieval outputs the top k candidate images c∈C with the smallest distance from the input image q as similar images of q.

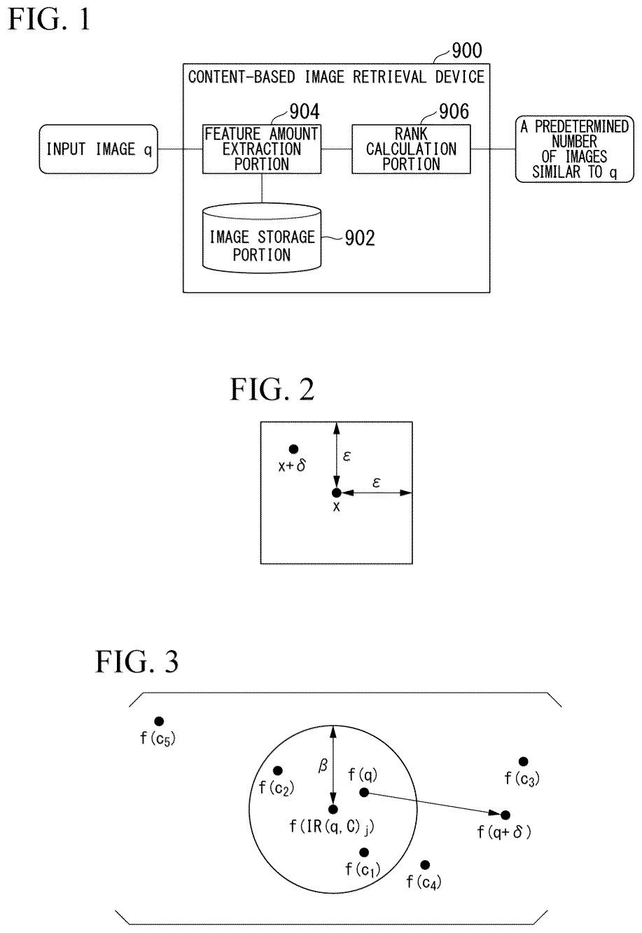

FIG. 1 is a schematic block diagram showing an example configuration of the content-based image retrieval device 900.

In a case where an input image q∈χ is given as a search query the content-based image retrieval device 900 retrieves and outputs images similar to q from a set of candidate images C={cᵢ∈χ}(i=1 to N). Here, χ represents the input space of images. The content-based image retrieval device 900 includes an image storage portion 902, a feature amount extraction portion 904, and a rank calculation portion 906.

The image storage portion 902 stores a group of candidate images (hereinbelow referred to as the candidate image group). C={cᵢ∈χ}(i=1 to N) is stored. Each cᵢ is called a candidate image. Note that the candidate image group C may be input to the content-based image retrieval device 900 without being stored in the storage portion.

The feature amount extraction portion 904 extracts the feature amount of the input image q and the image cᵢEC (i=1 to N) obtained from the image storage portion 902 using the feature amount extractor f. The feature amount extractor f is, for example, a function f·χ→Rⁿ from the image space of images χ to an n-dimensional vector space of a real number representing the feature amount (hereinbelow referred to as the feature amount space). This feature amount extractor f is a function that has been pre-learned using a deep learning model such as deep distance learning, for example. Deep distance learning learns the feature amount extractor f to compute feature amounts such that the distance between images with high similarity is close and the distance between images with low similarity is far.

The rank calculation portion 906 calculates the Euclidean distance dist(f(q), f(cᵢ)) between the extracted feature amount f(q) and each f(cᵢ) (i=1 to N). Then, the rank calculation portion 906 outputs the predetermined number of images cᵢ in order of decreasing distance as images similar to the input image q. The image that is j-th similar (j-th smallest distance) to the input image q is described as IR(q, C)ⱼ. IR stands for Image Retrieval.

The content-based image retrieval device that the robustness verification device 100 (200) targets for robustness verification is not limited to the content-based image retrieval device 900, as long as the feature amount extractor f can be used to rank the candidate image groups C with respect to the input image q.

The robustness verification device 100 (200) has as part of its input the input image q, the candidate image group C, and the feature amount extractor f, which are the parameters of the content-based image retrieval device 900.

### [Noise]

Next, an explanation shall be given about the noise, which is a small adversarial perturbation intentionally added to images, as assumed by the robustness verification device 100 (200).

An Adversarial Example (AX) is known to be a serious problem for the security of machine learning models. An adversarial example is data that is created by intentionally adding minute perturbations that cause machine learning models, such as feature amount extraction models, to make incorrect decisions. Perturbations added by an adversarial example are referred to as adversarial perturbations. Machine learning models may output different classes or values in a case where inputted with adversarial examples compared to data without adversarial perturbations.

Attacks by adversarial examples are also possible against content-based image retrieval using feature amount extraction models. In this case, the adversarial perturbation is noise, etc. added to the image. Two potential threats to content-based image retrieval by adversarial examples are the query attack and the candidate attack. A query attack is one that manipulates the output of content-based image retrieval by entering an adversarial example as an input image, which is the search query. A candidate attack is one that manipulates the output of content-based image retrieval by inputting adversarial examples as candidate images. Both attacks are accomplished by manipulating the output of the feature amount extraction model with adversarial examples.

An example of an attack using an adversarial example would be to give priority to recommending one's own products in a similar product search system used for online sales using content-based image retrieval. Another example would be impersonation of another person's face in a face recognition system using content-based image retrieval.

The robustness verification device 100 (200) verifies that, given the input space of images X, the rank of the input image q and the j-th nearest image IR(q, C)ⱼ in the candidate image group C varies only at most α, even if the image x∈χ is given noise δ∈χ with a radius of or less in the infinity norm L∞. That is, the robustness verification device 100 (200) verifies that the rank of image IR(q, C)ⱼ varies only at most α even if image x is a noise-laden image x+δ for ∀δ∈{δ∈χ|δ_{∞}≤ε}. The image x to which noise is added is the input image q in the case of the robustness verification device 100 and any candidate image cᵢ∈C in the case of the robustness verification device 200.

FIG. 2 is a diagram showing the range of image x+δ, where noise δ with a radius of ε or less in the infinity norm L∞ is applied to image x. As shown in FIG. 2, for the infinity norm, this range is a hypersphere with radius ε centered at x. The image x+δ is an element in this hypersphere. The infinity norm L_{∞} is an example, and the norm is not limited thereto.

### First Example Embodiment

Next, the first example embodiment of the present invention shall be described. The first example embodiment is a robustness verification device 100 that verifies the robustness of the content-based image retrieval device 900 against query attacks.

Let q be the input image that is the query of the content-based image retrieval device 900, and q+δ be the input image with noise δ of magnitude ε or less. Let IR(q, C)ⱼ be the j-th similar image to q that the content-based image retrieval device 900 retrieves from the candidate image group C={cᵢ∈χ}(i=1 to N) in a case where the input image q is input.

In this case, the robustness verification device 100 verifies whether the rank of IR(q, C)ⱼ does not change so much in a case where the input image q+δ is input to the content-based image retrieval device 900. Specifically, the robustness verification device 100 verifies whether the rank of IR(q, C)ⱼ varies only by at most α in the target image group C_{β} with low similarity to IR(q, C)ⱼ, even if the input image q+δ is input to the content-based image retrieval device 900.

[(α, β)-robustness verification against query attack]

First, (α, β)-robustness verification, which is a fundamental concept in a case where verifying robustness with the robustness verification device 100, shall be explained.

The (α, β)-robustness verification against query attacks is defined as follows.

Let α be a natural number greater than or equal to 0 and let β be a real number greater than or equal to 0. At this time, with respect to

$$\begin{matrix}[ Expression 1 ] & \\ ∀ δ ∈ \{ δ \vert δ ∈ χ , {‖ δ ‖}_{p} \leq ϵ \} & ( 1 )\end{matrix}$$

IR(q, C)ⱼ being (α, β)-robustly verified means that

$$\begin{matrix}[ Expression 2 ] & \\ Rank ( q , {IR ( q , C )}_{j} , {C}_{β} ) - α \leq Rank ( q + δ , {IR ( q , C )}_{j} , {C}_{β} ) \leq Rank ( q , {IR ( q , C )}_{j} , {C}_{β} ) + α & ( 2 )\end{matrix}$$

holds true. Here,

$$\begin{matrix}[ Expression 3 ] & \\ {C}_{β} = \{ {IR ( q , C )}_{j} \} ⋃ \{ c \vert c ∈ C , β \leq {‖ f ( c ) - f ( {IR ( q , C )}_{j} ) ‖}_{q} \} & ( 3 )\end{matrix}$$

is.

Expression (1) represents the range of noise δ imparted to the input image. χ represents the input space of images. “δ∈χ” denotes that δ is also an element of the input space of images. “δₚ” denotes the infinity norm L_{∞} of δ. “δₚ≤ε” indicates that the magnitude of δ is less than or equal to ε in a case where the infinity norm L_{∞} of δ is taken. This is illustrated in FIG. 2. The p-norm is not limited to the infinity norm, but can be 1, 2, or p norms.

Expression (3) expresses the set of images C_{B} (hereafter referred to as the target image group) subject to the robustness verification in Expression (2). “{IR(q, C)ⱼ}” indicates that IR(q, C)ⱼ (the candidate image j-th similar to q that the content-based image retrieval device 900 retrieves from the candidate image group C in a case where input image q is input) is included in C_{β}.

For “{c|c∈C, β≤f(c)−f(IR(q, C)ⱼ)_{q}}”, first, “c∈C” represents the condition that c is an element of the candidate image group C. “f(c)” represents the feature amount extracted by the feature amount extractor f for image c. This feature amount extractor f is the feature amount extractor of the content-based image retrieval device 900. “{β≤f(c)−f(IR(q, C)ⱼ)_{q}}” represents the condition that the magnitude in the q-norm of the difference between the feature amount of image IR(q, C)ⱼ and the feature amount of image c is greater than or equal to β. That is, such an image c is included in C_{β}. β is a parameter that determines the candidate images considered for variation in ranking. β represents that variation in ranking with images similar to IR(q, C)ⱼ is acceptable, by not including images with a distance difference less than β in C_{β}. The larger the value of β, the easier it is to achieve (α, β)-robustness verification. Note that the q-norm can be any of 1, 2, p, or infinity norms.

Expression (2) represents the specific conditions for (α, β)-robustness verification. Rank (q, c, C) represents the rank of image c in the candidate image group C with respect to similarity using the feature amount extractor f in a case where the input image is q. Therefore, “Rank (q+δ, IR(q, C)ⱼ, C_{β})” represents the rank of image IR(q, C)ⱼ in the target image group C_{β} calculated by Expression (3), with q+δ being the input image. “Rank (q, IR(q, C)ⱼ, C_{β})” represents the rank of image IR(q, C)ⱼ in the target image group C_{β} calculated by Expression (3), where q is the input image. Therefore, Expression (2) expresses the condition that the rank of image IR(q, C)ⱼ in the target image group C_{β} calculated by Expression (3) in a case where the input image is q+δ varies only at most α from the rank of image IR(q, C)ⱼ in a case where the input image is q. α is a parameter indicating the amount of variation in rank that is acceptable, i.e., that a ranking variation of at most α is permissible. The larger α is, the easier it is to verify (α, β)-robustness.

FIG. 3 shows a specific example of (α, β)-robustness verification. (α, β)-robustness verification verifies whether the rank of IR(q, C)ⱼ varies only at most α in the target image group C_{β} with low similarity to IR(q, C)ⱼ in a case where noise δ of magnitude ε or less is added to the input image q.

FIG. 3 shows an example of a feature space with the feature amount extractor f. The circle shown in FIG. 3 has radius β, with the center thereof being the point f(IR(q, C)ⱼ), which represents the feature amount by the feature amount extractor f of the image IR(q, C)ⱼ. f(q) and f(q+δ) are points representing the feature amounts by the feature amount extractor f of the input image q and the input image q+δ with noise δ, respectively. f(c₁), f(c₂), f(c₃), f(c₄) and f(c₅) are points representing the feature amounts by the feature amount extractor f of images c₁, c₂, c₃, c₄ and c₅ in the candidate image group C, respectively. The distance between the points represented by the feature amounts is the distance in the plane shown in FIG. 3.

As shown in FIG. 3, taking the parameter β to account for the change in ranking, the images that satisfy β≤f(c)−f(IR(q, C)ⱼ)_{q} in Expression (3) are c₃, c₄ and c₅ outside the circle. Therefore, C_{β}={IR(q, C)ⱼ, c₃, c₄, c₅}.

Since the ranking by the content-based image retrieval device 900 using the input image q before noise is applied is in order of proximity to f(q) in the images included in C_{β}, the images are ranked in the order of
1st: IR(q, C),
2nd: c₄
3rd: c₃
4th: c₅.

On the other hand, since the ranking by the content-based image retrieval device 900 using the input image q+δ after the noise δ is applied is in order of proximity to f(q+δ) in the images included in C_{β}, the images are ranked in the order of
1st: c₃
2nd: c₄
3rd: IR(q, C)ⱼ
4th: c₅.

Thus, in Expression (2), since Rank(q+δ, IR(q, C)ⱼ, C_{β})=3, and Rank(q, IR(q, C)ⱼ, C_{β})=1, Expression (2) is 1−α≤3≤1+α. Therefore, if α≥2, IR(q, C)ⱼ is (α, β)-robustness verified, and if α=0 or 1, IR(q, C)ⱼ is not (α, β)-robustness verified.

### [Robustness Verification Device 100]

The robustness verification device 100 performs the (α, β)-robustness verification described above, but accurate computation of (α, β)-robustness verification is difficult due to computational complexity issues. In other words, it is difficult for the robustness verification device 100 to verify Expression (2) for any δ that satisfies (1). Therefore, the robustness verification device 100, with respect to

$$\begin{matrix}[ Expression 4 ] & \\ ∀ δ ∈ \{ δ \vert δ ∈ χ , {‖ δ ‖}_{p} \leq ϵ \} & ( 4 )\end{matrix}$$

utilizes the ability to calculate the upper and lower limits of d(f(q+δ), f(c)) with minimal computational effort. Here, q is the input image while c is an element of the target image group C.

In other words, the robustness verification device 100 calculates the lower and upper limits that satisfy

$$\begin{matrix}[ Expression 5 ] & \\ \underline{{d}_{q}} ( f ( q ) , f ( c ) ) \leq d ( f ( q + δ ) , f ( c ) ) \leq \overline{{d}_{q}} ( f ( q ) , f ( c ) ) & ( 5 )\end{matrix}$$

Here, “d(f(q+δ), f(c))” represents the Euclidean distance d(f(q+δ), f(c)) between the feature amount f(q+δ) of the input image q with noise δ and the feature amount f(c) of image c. “d_{q}(f(q), f(c))” is the upper limit of d(f(q+δ), f(c)) for any δ satisfying Expression (4). The q in “ d_{q}” indicates that noise has been added to q. “_d_{q}(f(q), f(c))” is the lower limit of d(f(q+δ), f(c)) for any δ satisfying Expression (4). The q in “_d_{q}” indicates that noise has been added to q.

The robustness verification device 100 performs calculations using, for example, the well-known technique Interval Bound Propagation (IBP), described in the following non patent document. IBP is a method for computing the upper and lower limits of each element i of the feature amount f(q+δ) by sequentially computing the upper and lower limits of each element of the intermediate layer representation in each layer in a case where an image q+δ with noise δ added is input for noise δ∈{δ|δ_{∞}≤ε} with a magnitude in the infinity norm equal to or less than ε. Here, i represents the i-th element (1≤i≤n) of the feature amount, assuming that the feature amount is an n-dimensional vector.

### Non Patent Document

Sven Gowal, and 8 others, “On the Effectiveness of Interval Bound Propagation for Training Verifiably Robust Models,” The 2019 International Conference on Computer Vision (ICCV 2019), 2019.

The robustness verification device 100 uses IBP to calculate the upper limit f(q)ᵢ and lower limit _f(q)ᵢ of f(q+δ)ᵢ, where i is the i-th element of the n-dimensional vector. The robustness verification device 100, using the upper limit and lower limit, then calculates the upper limit d_{q}(f(q), f(c)) and lower limit _d_{q}(f(q), f(c)) of d(f(q+δ) with Expressions (6) and (7), respectively.

$$\begin{matrix}[ Expression 6 ] & \\ \overline{{d}_{q}} ( f ( q ) , f ( c ) ) = {( {\sum }_{i} max {( {\vert {\overline{f} ( q )}_{i} - {f ( c )}_{i} \vert}_{1} , {\vert {f ( c )}_{i} - {\underline{f} ( q )}_{i} \vert}_{1} )}^{2} )}^{\frac{1}{2}} & ( 6 )\end{matrix}$$

$$\begin{matrix}[ Expression 7 ] & \\ \underline{{d}_{q}} ( f ( q ) , f ( c ) ) = {( {\sum }_{i} min {( 0 , {\overline{f} ( q )}_{i} - {f ( c )}_{i} , {f ( c )}_{i} - {\underline{f} ( q )}_{i} )}^{2} )}^{\frac{1}{2}} & ( 7 )\end{matrix}$$

In Expression (6), “| f(q)ᵢ−f(c)ᵢ|₁” represents the absolute value of the difference between the upper limit of the i-th element of the feature amount of the input image q and the i-th element of the feature amount of the image c. “|f(c)ᵢ−_f(q)ᵢ|₁” represents the absolute value of the difference between the i-th element of the feature amount of image c and the lower limit of the i-th element of the feature amount of input image q. The right-hand side of Expression (6) represents the square of the larger of these values squared and summed over all elements i in dimension n. This value is the upper limit d_{q}(f(q), f(c)) of d(f(q+δ), f(c)).

In Expression (7), “ f(q)ᵢ−f(c)ᵢ” represents the difference between the upper limit of the i-th element of the feature amount of the input image q and the i-th element of the feature amount of image c. “f(c)ᵢ−_f(q)ᵢ” represents the difference between the i-th element of the feature of image c and the lower limit of the i-th element of the feature amount of input image q. The right-hand side of Expression (7) represents the square of the smaller of these values and 0 squared and summed over all elements i in dimension n. This value is the lower limit _d(f(q), f(c)) of d(f(q+δ), f(c)).

In a case where the robustness verification device 100 calculates the upper and lower limits of Expression (5) using the IBP-based calculation method described above, the norm in Expression (4) is the infinity norm.

The robustness verification device 100 may also calculate the upper and lower limits of d(f(q+δ), f(c)) using calculation methods other than IBP, in which case the norm in Expression (4) is not limited to the infinity norm.

The robustness verification device 100 performs (α, β)-robustness verification using the upper limit d_{q}(f(q), f(c)) and lower limit _d_{q}(f(q), f(c)) of d(f(q+δ), f(c)).

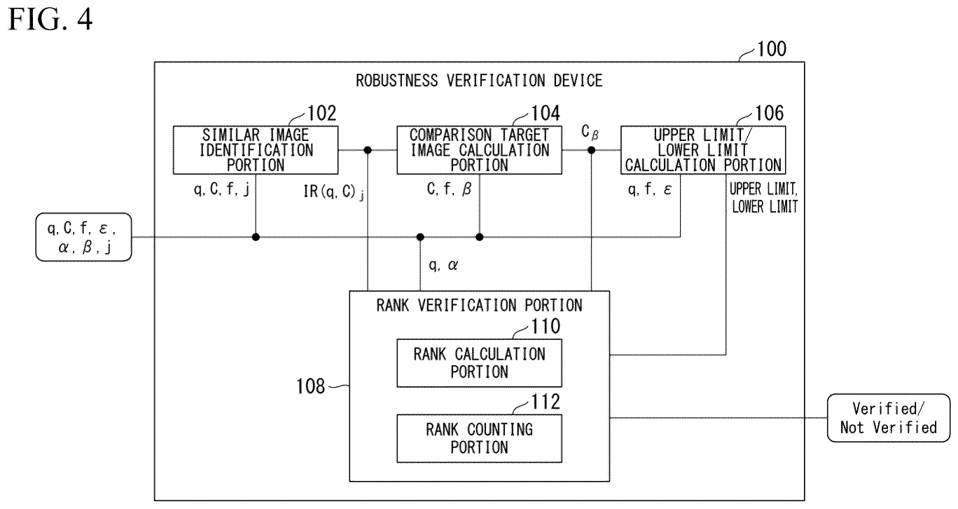

FIG. 4 is a schematic block diagram showing an example of the functional configuration of the robustness verification device 100 according to the first example embodiment. The robustness verification device 100 includes a similar image identification portion 102, a comparison target image calculation portion 104, an upper limit/lower limit calculation portion 106, and a rank verification portion 108. The rank verification portion 108 includes a rank calculation portion 110 and a rank counting portion 112. A query, input image q∈χ, a candidate image group C={cᵢ∈χ}(i=1 to N), feature amount extractor f, perturbation size ε, parameters α, β and rank j are input to the robustness verification device 100. The robustness verification device 100 may include a storage portion that stores the candidate image group C without the candidate image group C being input.

The rank verification portion 108 corresponds to an example of a rank verification means.

The similar image identification portion 102 receives the input image q, candidate image group C, feature amount extractor f, and rank j, and outputs the image IR(q, C)ⱼ that is the j-th most similar to the input image q in the candidate image group C. Specifically, the similar image identification portion 102 uses the feature amount extractor f to calculate the feature amounts f(q), f(cᵢ) (i=1 to N) of the input image q and each candidate image cᵢ∈C. Then, the similar image identification portion 102 calculates the Euclidean distance dist(f(q), f(cᵢ)) between the feature amount f(q) and each f(cᵢ). The similar image identification portion 102 then outputs the image that is j-th similar (j-th smallest distance) to the input image q as IR(q, C)ⱼ. The similar image identification portion 102 corresponds to the search of the content-based image retrieval device 900.

The similar image identification portion 102 is an example of a similar image identification means.

IR(q, C)ⱼ, the candidate image group C, the feature amount extractor f, and the parameter β are input to the comparison target image calculation portion 104, which calculates the target image group C_{β}, which is the set of images subject to robustness verification as shown in Expression (8).

$$\begin{matrix}[ Expression 8 ] & \\ {C}_{β} = \{ {IR ( q , C )}_{j} \} ⋃ \{ c \vert c ∈ C , β \leq {‖ f ( c ) - f ( {IR ( q , C )}_{j} ) ‖}_{q} \} & ( 8 )\end{matrix}$$

Specifically, the comparison target image calculation portion 104 includes IR(q, C)ⱼ in C_{β}. The comparison target image calculation portion 104 calculates the feature amounts f(IR(q, C)) and f(cⱼ) for IR(q, C)ⱼ and each target image c of the candidate image group C by the feature amount extractor f. Then, the comparison target image calculation portion 104 determines whether “f(c)−f(IR(q, C)ⱼ)_{q}”, the magnitude of the difference in the q-norm of the feature amounts, is equal to or greater than β. If β is greater than or equal to β, the target image c is included in C_{β}. The comparison target image calculation portion 104 includes the target image c in C_{β}.

Note that β is a parameter that determines the candidate images to be considered for ranking variation. B represents that variation in ranking with images similar to IR(q, C)ⱼ is acceptable by not including images with a distance difference less than β in C_{β}. The larger the value of β, the easier it is to achieve (α, β)-robustness verification. Note that the q-norm can be any of 1, 2, p, or infinity norms.

The comparison target image calculation portion 104 corresponds to an example of a comparison target image calculation means.

The target image group C_{β} to be verified for robustness, the input image q, the feature amount extractor f, and the perturbation size e are input to the upper limit/lower limit calculation portion 106, which, for each target image c∈C_{β}, calculates the upper limit d_{q}(f(q), f(c)) and lower limit _d_{q}(f(q), f(c)) of d(f(q+δ), f(c)) satisfying Expression (5) for any δ satisfying Expression (4) described above.

Specifically, the upper limit/lower limit calculation portion 106 uses the aforementioned IBP to calculate, for each target image c∈C_{β}, the upper limit d_{q}(f(q), f(c)) of d(f(q+δ), f(c)) shown in Expression (6) and the lower limit _d_{q}(f(q), f(c)) of d(f(q+δ), f(c)) shown in Expression (7).

The method by which the upper and lower limits of d(f(q+δ), f(c)) are calculated by the upper limit/lower limit calculation portion 106 is not limited to IBP, and other methods may be used.

The upper limit/lower limit calculation portion 106 is an example of the upper limit/lower limit calculation means.

The rank verification portion 108 receives as input the input image q, the image IR(q, C)ⱼ, the target image group C_{β} that is subject to robustness verification, the upper limit d_{q}(f(q), f(c)) and lower limit _d_{q}(f(q), f(c)) of d(f(q+δ), f(c)) for each target image c∈C_{β}, and the parameter α. Then, the rank verification portion 108 performs (α, β)-robustness verification, i.e., verifies that the rank of image IR(q, C)ⱼ in the target image group C_{β} in a case where the input image is q+δ varies only at most α with respect to the rank of image IR(q, C)ⱼ in a case where the input image is q.

The conditions for (α, β)-robustness verification performed by the rank verification portion 108 are not based on the definition in Expression (2), but on the upper and lower limits of d(f(q+δ), f(c)). Specifically, the rank verification portion 108 verifies whether or not the following Expressions (9) and (10) are satisfied.

$$\begin{matrix}[ Expression 9 ] & \\ Rank ( q , {IR ( q , C )}_{j} , {C}_{β} ) - α \leq 1 + {\sum }_{c ∈ {C}_{β} / {IR ( q , C )}_{j}} 1 [ \overline{{d}_{q}} ( f ( q ) , f ( c ) ) < \underline{{d}_{q}} ( f ( q ) , f ( {IR ( q , C )}_{j} ) ) ] & ( 9 )\end{matrix}$$

$$\begin{matrix}[ Expression 10 ] & \\ \vert {C}_{β} \vert - {\sum }_{c ∈ {C}_{β} / {IR ( q , C )}_{j}} 1 [ \overline{{d}_{q}} ( f ( q ) , f ( {IR ( q , C )}_{j} ) ) < \underline{{d}_{q}} ( f ( q ) , f ( c ) ) ] \leq Rank ( q , {IR ( q , C )}_{j} , {C}_{β} ) + α & ( 10 )\end{matrix}$$

The rank calculation portion 110 of the rank verification portion 108 finds “Rank(q, IR(q, C)ⱼ, C_{β})” in Expressions (9) and (10). “Rank (q, IR(q, C)ⱼ, C_{β})” represents the rank of image IR(q, C)ⱼ in the target image group C_{β} calculated by Expression (8) in a case where the input image is q. Specifically, the rank calculation portion 110 calculates the rank by using the feature amount extractor f to find the Euclidean distance between each feature amount f(q), f(IR (q, C)ⱼ), and f(c) for q, IR(q, C)ⱼ, ∀c∈C_{β}. The rank calculation portion 110 is an example of a rank calculation means.

The rank counting portion 112 of the rank verification portion 108 calculates the right side of Expression (9) and the left side of Expression (10).

The rank counting portion 112 first calculates the right side of Expression (9). “ d_{q}(f(q), f(c))” is the upper limit of d(f(q+δ), f(c)) and “_d_{q}(f(q), f(IR(q, C)ⱼ))” is the lower limit of d(f(q+δ), f(IR(q, C)ⱼ)). The rank counting portion 112 counts 1 for “1[ d_{q}(f(q), f(c))<_d_{q}(f(q), f(IR(q, C)ⱼ))]” in a case where the above upper limit is less than the above lower limit.

The rank counting portion 112 counts “1[ d_{q}(f(q), f(c))<d_{q}(f(q), f(IR(q, C)ⱼ))]” for all elements c except IR(q, C)ⱼ from the target image group C_{β}, and then adds 1 to the count.

The rank counting portion 112 then calculates the left side of Expression (10). “ d_{q}(f(q), f(IR(q, C)ⱼ)” is the upper limit of d(f(q+δ), f(IR(q, C)ⱼ)) and “_d_{q}(f(q), f(c))” is the lower limit of d(f(q+δ), f(c)). The rank counting portion 112 counts as 1 in a case where the aforementioned upper limit is less than the aforementioned lower limit for “1[ d_{q}(f(q), f(IR(q, C)ⱼ))<_d_{q}(f(q), f(c))]”.

The rank counting portion 112 counts “1[ d_{q}(f(q), f(IR(q, C)ⱼ))<_d_{q}(f(q), f(c))]” for all elements c except IR(q, C)ⱼ from the target image group C_{β}, and subtracts the counted value from the element number |C_{β}| of C_{β}.

The rank counting portion 112 is an example of a rank counting means.

The rank verification portion 108 verifies whether the value of the right side of the calculated Expression (9) is equal to or greater than “Rank(q, IR(q, C)ⱼ, C_{β})−α”, and the value of the left side of the calculated Expression (10) is equal to or less than “Rank(q, IR(q, C)ⱼ, C_{β})+α”. Here, α is a parameter indicating the amount of variation in ranking that is acceptable, i.e., that a ranking variation of at most α is permissible. The larger α is, the easier it is to verify (α, β)-robustness.

If the condition is satisfied, the rank verification portion 108 outputs that (α, β)-robustness is verified, and if the condition is not satisfied, it outputs that (α, β)-robustness is not verified.

If the conditions in Expressions (9) and (10), which are verified by the rank verification portion 108, hold, then the conditions in Expression (2) of the (α, β)-robustness verification are known to hold (sufficient conditions). Thus, the conditions in Expressions (9) and (10) mean that the rank of image IR(q, C)ⱼ in the target image group C_{β} in a case where the input image is q+δ varies only at most α with respect to the rank of image IR(q, C)ⱼ in a case where the input image is q.

Because the upper limit/lower limit calculation portion 106 of the robustness verification device 100 uses the upper and lower limits of d(f(q+δ), f(c)), according to the definition of (α, β)-robustness verification, there is a possibility that inputs which would originally be verified may be deemed as not verified in the robustness verification device 100.

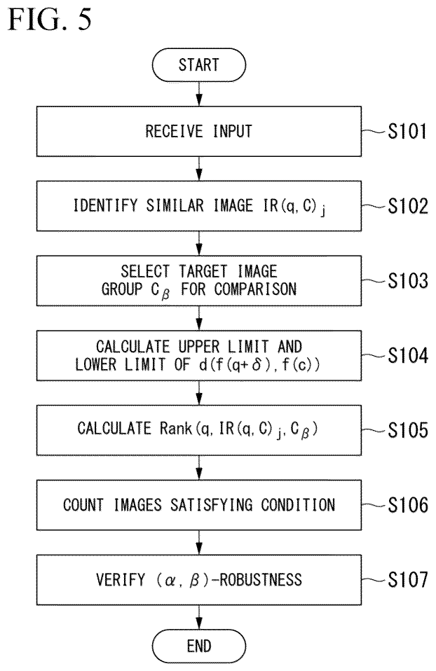

Next, the operation of the robustness verification device 100 is described with reference to FIG. 5. FIG. 5 is a flowchart showing an example of the processing procedure in which the robustness verification device 100 performs (α, β)-robustness verification.

First, the robustness verification device 100 receives as input input image q∈χ, which is the query candidate image group C={cᵢ∈χ}(i=1 to N), feature amount extractor f, perturbation size e, parameters α, β, and rank j (Step S101).

Next, the similar image identification portion 102 identifies the image IR(q, C)ⱼ that is the j-th most similar to the input image q in the candidate image group C. Specifically, the similar image identification portion 102 uses the feature amount extractor f to calculate the feature amounts f(q), f(cᵢ) (i=1 to N) of the input image q and each candidate image cᵢ∈C, and calculates the Euclidean distance dist (f(q), f(cᵢ)) between the feature amounts f(q) and each f(c). Then, the similar image identification portion 102 identifies the image with the j-th smallest distance from the input image q as IR(q, C)ⱼ (Step S102).

Next, the comparison target image calculation portion 104 selects the target image group C_{β}, which is the set of images to be subject to robustness verification. Specifically, the comparison target image calculation portion 104 includes IR(q, C)₃ in C_{β}. The comparison target image calculation portion 104 calculates the feature amounts f(IR(q, C)ⱼ) and f(cᵢ) for IR(q, C)ⱼ and each target image c of the candidate image group C. Then, the comparison target image calculation portion 104 includes that target image in C_{β} if “f(c)−f(IR(q, C)ⱼ)_{q}”, the magnitude of the difference in the q-norm of the feature amounts, is equal to or greater than β (Step S103).

Next, for each target image c in the target image group C_{β}, the upper limit/lower limit calculation portion 106 calculates the upper limit d_{q}(f(q), f(c)) and lower limit _d_{q}(f(q), f(c)) of d(f(q+δ), f(c)) satisfying Expression (5) for any δ satisfying Expression (4) (Step S104).

Next, the rank calculation portion 110 of the rank verification portion 108 calculates Rank(q, IR(q, C)ⱼ, C_{β}). Specifically, the rank calculation portion 110 calculates the rank by finding the Euclidean distance between each feature amount f(q), f(IR(q, C)ⱼ), f(cᵢ) of q, IR(q, C)ⱼ, ∀c∈C_{β} using the feature amount extractor f (Step S105).

Next, the rank counting portion 112 of the rank verification portion 108 calculates the right side of Expression (9). That is, the rank counting portion 112 counts “1[ d_{q}(f(q), f(c))<d_{q}(f(q), f(IR(q, C)ⱼ))]” for all elements c except IR(q, C)ⱼ from the target image group C_{β} in Expression (9), and then adds 1 to the count. The rank counting portion 112 also calculates the left side of Expression (10). In other words, the rank counting portion 112 counts “1[ d_{q}(f(q), f(IR(q, C)ⱼ))<d_{q}(f(q), f(c))]” for all elements c except IR(q, C)ⱼ from the target image group C_{β} in Expression (10), and subtracts the counted value from the element number |C_{β}| of C_{β} (Step S106).

Next, the rank verification portion 108 verifies whether the value of the right side of the calculated Expression (9) is equal to or greater than “Rank(q, IR(q, C)ⱼ, C_{β})−α”, and the value of the left side of the calculated Expression (10) is equal to or less than “Rank(q, IR(q, C)ⱼ, C_{β})+α”. If the condition holds, the rank verification portion 108 outputs that (α, β)-robustness is verified, and if the condition does not hold, it outputs that (α, β)-robustness is not verified (Step S107).

After Step S107, the robustness verification device 100 ends the process in FIG. 5.

The robustness verification device 100 may not perform (α, β)-robustness verification only for a specific rank j, and may perform (α, β)-robustness verification for multiple j, or for all j with 1≤j≤N.

As explained above, the similar image identification portion 102 identifies similar images IR(q, C)ⱼ. The comparison target image calculation portion 104 calculates the target image group C_{β} to be subject to robustness verification. The upper limit/lower limit calculation portion 106 calculates the upper and lower limits of d(f(q+δ), f(c)) for each target image. The rank verification portion 108 verifies the conditions in Expressions (9) and (10).

Thereby, the robustness verification device 100 can perform (α, β)-robustness verification, i.e., can verify that the rank of image IR(q, C)ⱼ in the target image group Cs in a case where the input image is q+δ varies only at most α with respect to the rank of image IR(q, C)ⱼ in a case where the input image is q. In other words, the robustness verification device 100 can verify whether, in content-based image retrieval, the search results are not affected even if an adversarial example in which adversarial perturbation is applied to an input image that is a query is applied.

For each target image c in the target image group C_{β} subject to robustness verification, the upper limit d_{q}(f(q), f(c)) and lower limit _d_{q}(f(q), f(c)) of d(f(q+δ), f(c)) are calculated for any δ satisfying Expression (4). The robustness verification device 100 then uses these upper and lower limits to perform (α, β)-robustness verification. This allows the robustness verification device 100 to perform (α, β)-robustness verification with a small amount of computation (practical computation time).

In addition, the comparison target image calculation portion 104 uses the parameter δ to allow for variation in ranking in a case where determining the target image group C_{β}.

This allows the robustness verification device 100 to adjust the accuracy of the verification, such as making (α, β)-robustness verification easier as β increases.

The rank verification portion 108 also uses the parameter α to determine the amount of rank that is acceptable.

This allows the robustness verification device 100 to adjust the accuracy of the verification, such as the larger α is, the easier it is for (α, β)-robustness verification to be performed.

### Second Example Embodiment

Next, the second example embodiment of the present invention shall be described. The second example embodiment is a robustness verification device 200 that verifies the robustness of the content-based image retrieval device 900 against candidate attacks.

Let q be the input image that is the query of the content-based image retrieval device 900. Let IR(q, C)ⱼ be the j-th similar image to q that the content-based image retrieval device 900 retrieves from the candidate image group C={cᵢ∈χ}(i=1 to N) in a case where the input image q is input. The candidate image group to which noise δᵢ(i=1 to N) of magnitude ε or less is added is denoted as ˜C{cᵢ+δᵢ|cᵢ ∈C}(i=1 to N).

In this case, the robustness verification device 200 verifies whether the rank of IR(q, C)ⱼ does not vary that much, even if the candidate image group of the content-based image retrieval device 900 is the noise-added candidate image group ˜C. Specifically the robustness verification device 200 verifies whether the rank of IR(q, C)ⱼ varies only at most α from the ranking j in a case where the candidate image group is C even if the candidate image group of the content-based image retrieval device 900 is ˜C.

### [α-Robustness Verification Against Candidate Attacks]

First, α-robustness verification, which is a fundamental concept in verifying robustness with the robustness verification device 200, shall be described.

α-robustness verification against query attacks is defined as follows.

Let α be a natural number greater than or equal to 0. At this time, with respect to

$$\begin{matrix}[ Expression 11 ] & \\ ∀ {δ}_{1} , … , ∀ {δ}_{N} ∈ \{ δ \vert δ ∈ χ , {‖ δ ‖}_{p} \leq ϵ \} & ( 11 )\end{matrix}$$

IR(q, C)ⱼ is considered to be α-robustness verified if

$$\begin{matrix}[ Expression 12 ] & \\ j - α \leq Rank ( q , {IR ( q , C )}_{j} , \tilde{C} ) \leq j + α & ( 12 )\end{matrix}$$

holds true. Here,

$$\begin{matrix}[ Expression 13 ] & \\ \tilde{C} = {\{ {c}_{i} + {δ}_{i} \vert {c}_{i} ∈ C \}}_{i = 1}^{N} & ( 13 )\end{matrix}$$

is.

Expression (11) represents the range of noise δᵢ applied to each image cᵢ(i=1 to N) of the candidate image group C. χ represents the input space of images. “δ∈χ” denotes that δ is also an element of the input space of images. “δₚ” denotes the infinity norm L_{∞} of δ. “δ_{p≤ε}” indicates that the magnitude of δ is less than or equal to ε in a case where the infinity norm L_{∞} of δ is taken. This is illustrated in FIG. 2. “∀δ₁, . . . , ∀δ_{N}∈{δ∈χ, δ_{p≤ε}}” denotes that each noise δᵢ is an arbitrary element of the set satisfying this condition. The p-norm is not limited to the infinity norm, but can be 1, 2, or p norms.

Expression (13) expresses the set of images ˜C (hereafter referred to as the target image group) subject to the robustness verification in Expression (12). “˜C={cᵢ+δᵢ|cᵢ∈C}(i=1 to N)” indicates that for each candidate image cᵢ of the candidate image group C, the image cᵢ+δᵢ with any noise δᵢ is an element of the target image group ˜C. Note that, β, a parameter that determines the candidate images to be considered for ranking changes, is not introduced, as in the case of query attacks. This is because the robustness verification in a candidate attack assumes that noise can ride on any candidate image cᵢ (i=1 to N) in the candidate image group C. In other words, this is because, assuming the feature amount extractor f, since f(cᵢ) (i=1 to N) can be modified by noise, it is not possible to exclude similar images based on distance in the feature amount space, as in the case of a query attack.

Expression (12) represents the specific condition for α-robustness verification. Rank (q, c, C) represents the rank of image c within the candidate image group C with respect to similarity using the feature amount extractor f in a case where the input image is q. The feature amount extractor f is the feature amount extractor of the content-based image retrieval device 900. Therefore, “Rank (q, IR(q, C)ⱼ, ˜C)” represents the rank of image IR(q, C)ⱼ in the target image group ˜C obtained by Expression (13), where the input image is q. Also, “j” stands for Rank (q, IR(q, C)ⱼ, C), which is the rank j of image IR(q, C)ⱼ in a case where the input image in candidate image group C is q. Therefore, Expression (12) expresses the condition that the rank of image IR(q, C)ⱼ in the target image group ˜C calculated by Expression (13) in a case where the input image is q varies only at most α with respect to the rank of image IR(q, C)ⱼ in a case where the input image is q. α is a parameter indicating the amount of variation in rank that is acceptable, i.e. that a ranking variation of at most α is acceptable. The larger α is, the easier it is to verify α-robustness.

### [Robustness Verification Device 200]

The robustness verification device 200 performs the α-robustness verification described above, but accurate computation of α-robustness verification is difficult due to computational complexity issues. In other words, it is difficult for the robustness verification device 200 to verify Expression (12) for any δ that satisfies Expression (11). Therefore, the robustness verification device 200, with respect to

$$\begin{matrix}[ Expression 14 ] & \\ ∀ δ ∈ \{ δ \vert δ ∈ χ , {‖ δ ‖}_{p} \leq ϵ \} & ( 14 )\end{matrix}$$

utilizes the ability to calculate the upper and lower limits of d(f(q), f(c+δ)) with minimal computational effort. Here, q is the input image while c is an element of the candidate image group C.

In other words, the robustness verification device 200 calculates the lower and upper limits that satisfy

$$\begin{matrix}[ Expression 15 ] & \\ \underline{{d}_{c}} ( f ( q ) , f ( c ) ) \leq d ( f ( q ) , f ( c + δ ) ) \leq \overline{{d}_{c}} ( f ( q ) , f ( c ) ) & ( 15 )\end{matrix}$$

where “d(f(q), f(c+δ))” is the Euclidean distance d(f(q), f(c+δ)) between the feature amount f(q) of the input image q and the feature amount f(c+δ) of image c with noise δ. “ d_{c}(f(q), f(c))” is the upper limit of d(f(q), f(c+δ)) for any δ satisfying Expression (14). The c in “ d_{c}” indicates that noise has been added to c. “_dc(f(q), f(c))” is the lower limit of d(f(q), f(c+δ)) for any δ satisfying Expression (14). The c in “_d_{c}” indicates that noise has been added to c.

The robustness verification device 200 performs calculations using, for example, the well-known technique Interval Bound Propagation (IBP), described in the aforementioned non patent document. IBP is a method for computing the upper and lower limits of each element i of the feature amount f(x+δ) by sequentially computing the upper and lower limits of each element of the intermediate layer representation in each layer in a case where an image x+S with noise S added is input for noise δ∈{δ|δ∥_{∞≤ε}} with a magnitude in the infinity norm equal to or less than ε. Here, i represents the i-th element (1≤i≤n) of the feature amount, assuming that the feature amount is an n-dimensional vector.

The robustness verification device 200 uses IBP to calculate the upper limit f(q)ᵢ and lower limit _f(q)ᵢ of f(c+δ)₁, where i is the i-th element of the n-dimensional vector. The robustness verification device 200, using the upper limit and lower limit, then calculates the upper limit d_{c}(f(q), f(c)) and lower limit _d_{c}(f(q), f(c)) of d(f(q), f(c+δ) with Expressions (16) and (17), respectively.

$$\begin{matrix}[ Expression 16 ] & \\ \overline{{d}_{c}} ( f ( q ) , f ( c ) ) = {( {\sum }_{i} max {( {\vert {\overline{f} ( c )}_{i} - {f ( q )}_{i} \vert}_{1} , {\vert {f ( q )}_{i} - {\underline{f} ( c )}_{i} \vert}_{1} )}^{2} )}^{\frac{1}{2}} & ( 16 )\end{matrix}$$

$$\begin{matrix}[ Expression 17 ] & \\ \underline{{d}_{c}} ( f ( q ) , f ( c ) ) = {( {\sum }_{i} min {( 0 , {\overline{f} ( c )}_{i} - {f ( q )}_{i} , {f ( q )}_{i} - {\underline{f} ( c )}_{i} )}^{2} )}^{\frac{1}{2}} & ( 17 )\end{matrix}$$

In Expression (16), “| f(c)ᵢ−f(q)ᵢ|1” represents the absolute value of the difference between the upper limit of the i-th element of the feature amount of the image c and the i-th element of the feature amount of the input image q. “|f(q)ᵢ−_f(c)ᵢ|1” represents the absolute value of the difference between the i-th element of the feature amount of input image q and the lower limit of the i-th element of the feature amount of image c. The right-hand side of Expression (16) represents the square of the larger of these values squared and summed over all elements i in dimension n. This value is the upper limit d_{c}(f(q), f(c)) of d(f(q), f(c+δ)).

In Expression (17), “ f(c)ᵢ−f(q)ᵢ” represents the difference between the upper limit of the i-th element of the feature amount of the image c and the i-th element of the feature amount of input image q. “f(q)ᵢ−_f(c)ᵢ” represents the difference between the i-th element of the feature of input image q and the lower limit of the i-th element of the feature amount of image c. The right-hand side of Expression (17) represents the square of the smaller of these values and 0 squared and summed over all elements i in dimension n. This value is the lower limit _d_{c}(f(q), f(c)) of d(f(q), f(c+δ)).

In a case where the robustness verification device 200 calculates the upper and lower limits of Expression (15) using the IBP-based calculation method described above, the norm in Expression (14) is the infinity norm.

The robustness verification device 200 may also calculate the upper and lower limits of d(f(q), f(c+δ)) using calculation methods other than IBP, in which case the norm in Expression (4) is not limited to the infinity norm.

The robustness verification device 200 performs α-robustness verification by using the upper limit d_{c}(f(q), f(c)) and lower limit _d_{c}(f(q), f(c)) of d(f(q), f(c+δ)).

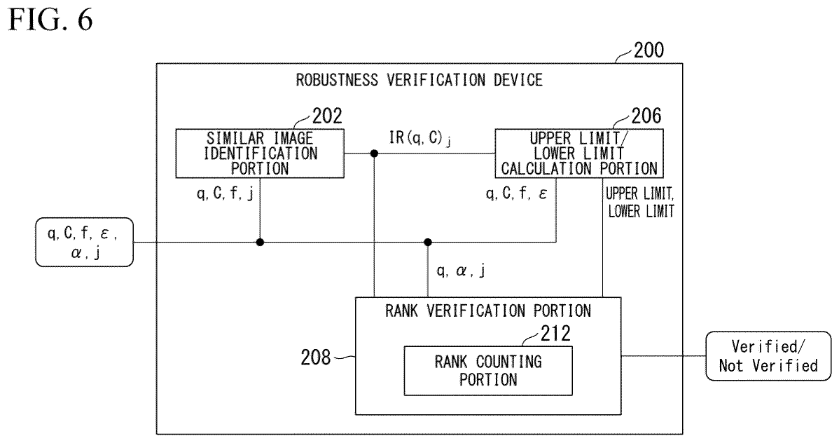

FIG. 6 is a schematic block diagram showing an example of the functional configuration of the robustness verification device 200 according to the second example embodiment. The robustness verification device 200 includes a similar image identification portion 202, an upper limit/lower limit calculation portion 206, and a rank verification portion 208. The rank verification portion 208 includes a rank counting portion 212. A query, input image q∈χ, a candidate image group C={cᵢ∈χ}(i=1 to N), feature amount extractor f, perturbation size ε, parameter α and rank j are input to the robustness verification device 200. The robustness verification device 200 may include a storage portion that stores the candidate image group C without the candidate image group C being input.

The similar image identification portion 202 receives the input image q, candidate image group C, feature amount extractor f, and rank j, and outputs the image IR(q, C)ⱼ that is the j-th most similar to the input image q in the candidate image group C. Specifically, the similar image identification portion 202 uses the feature amount extractor f to calculate the feature amounts f(q), f(cᵢ) (i=1 to N) of the input image q and each candidate image cᵢEC. Then, the similar image identification portion 202 calculates the Euclidean distance dist(f(q), f(cᵢ)) between the feature amount f(q) and each f(cᵢ). The similar image identification portion 202 then outputs the image that is j-th similar (j-th smallest distance) to the input image q as IR(q, C)ⱼ. The similar image identification portion 202 corresponds to the search of the content-based image retrieval device 900.

The candidate image group C, the input image q, the feature amount extractor f, and the perturbation size e are input to the upper limit/lower limit calculation portion 206, which, for each target image c∈C, calculates the upper limit d_{c}(f(q), f(c)) and lower limit _d_{c}(f(q), f(c)) of d(f(q), f(c+δ)) satisfying Expression (5) for any δ satisfying Expression (14) described above.

Specifically, the upper limit/lower limit calculation portion 206 uses the aforementioned IBP to calculate, for each target image c∈C_{β}, the upper limit d_{c}(f(q), f(c)) of d(f(q), f(c+δ)) shown in Expression (16) and the lower limit _d_{c}(f(q), f(c)) of d(f(q), f(c+δ)) shown in Expression (17).

The method by which the upper and lower limits of d(f(q), f(c+δ)) are calculated by the upper limit/lower limit calculation portion 206 is not limited to IBP, and other methods may be used.

The rank verification portion 208 receives as input the input image q, the image IR(q, C)ⱼ, the candidate image group C, the upper limit d_{c}(f(q), f(c)) and lower limit _d_{c}(f(q), f(c)) of d(f(q), f(c+δ)) for each target image c∈C, and the parameter α. Then, the rank verification portion 208 performs α-robustness verification, i.e., verifies, in a case where the target image group with noise added to the candidate image group C is denoted as ˜C, that the rank of image IR(q, C)ⱼ in the target image group ˜C in a case where the input image is q varies only at most α with respect to the rank j of image IR(q, C)ⱼ in a case where the input image is q.

The conditions for α-robustness verification performed by the rank verification portion 208 are not based on the definition in Expression (12), but on the upper and lower limits of d(f(q), f(c+δ)). Specifically, the rank verification portion 208 verifies whether or not the following Expressions (18) and (19) are satisfied.

$$\begin{matrix}[ Expression 18 ] & \\ j - α \leq 1 + {\sum }_{c ∈ C / {IR ( q , C )}_{j}} 1 [ \overline{{d}_{c}} ( f ( q ) , f ( c ) ) < \underline{{d}_{c}} ( f ( q ) , f ( {IR ( q , C )}_{j} ) ) ] & ( 18 )\end{matrix}$$

$$\begin{matrix}[ Expression 19 ] & \\ N - {\sum }_{c ∈ C / {IR ( q , C )}_{j}} 1 [ \overline{{d}_{c}} ( f ( q ) , f ( {IR ( q , C )}_{j} ) ) < \underline{{d}_{c}} ( f ( q ) , f ( c ) ) ] \leq j + α & ( 19 )\end{matrix}$$

The rank counting portion 212 of the rank verification portion 208 calculates the right side of Expression (18) and the left side of Expression (19).

The rank counting portion 212 first calculates the right side of Expression (18). “ d_{c}(f(q), f(c))” is the upper limit of d(f(q), f(c+δ)) while “_d_{c}(f(q), f(IR(q, C)ⱼ))” is the lower limit of d(f(q), f(IR(q, C)ⱼ+δ)). The rank counting portion 212 counts as 1 in a case where the aforementioned upper limit is less than the aforementioned lower limit for “1[ d_{c}(f(q), f(c))<d_{c}(f(q), f(IR(q, C)ⱼ))]”.

The rank counting portion 212 counts “1[ d_{c}(f(q), f(c))<_d_{c}(f(q), f(IR(qc C)ⱼ))]” for all elements c except IR(q, C)ⱼ from the candidate image group C, and then adds 1 to the count.

The rank counting portion 212 then calculates the left side of Expression (19). “ d_{c}(f(q), f(IR(q, C)ⱼ))” is the upper limit of d(f(q), f(IR(q, C)ⱼ+δ)) while “_d_{c}(f(q), f(c))” is the lower limit of d(f(q), f(c+δ)). The rank counting portion 212 counts as 1 in a case where the aforementioned upper limit is less than the aforementioned lower limit for “1[ d_{c}(f(q), f(IR(q, C)ⱼ))<_d_{c}(f(q), f(c))]”.

The rank counting portion 212 counts “1[ d_{c}(f(q), f(IR(q, C)ⱼ))<_d_{c}(f(q), f(c))]” for all elements c except IR(q, C)ⱼ from the candidate image group C, and subtracts the counted value from the element number N of C.

The rank verification portion 208 verifies whether the value of the right side of the calculated Expression (18) is equal to or greater than “j−α”, and the value of the left side of the calculated Expression (19) is equal to or less than “j+α”. Note that “j” is Rank(q, IR(q, C)ⱼ, C), which is the rank of image IR(q, C)ⱼ in terms of similarity with input image q in a case where no noise is added to candidate image group C. Here, α is a parameter indicating the amount of variation in ranking that is permitted, i.e., that a ranking variation of at most α is permissible. The larger α is, the easier it is to verify α-robustness.

If the condition holds, the rank verification portion 208 outputs that α-robustness is verified, and if the condition does not hold, it outputs that α-robustness is not verified.

If the conditions in Expressions (18) and (19), which are verified by the rank verification portion 208, hold, then the condition in Expression (12) of the α-robustness verification is known to hold (sufficient conditions). Accordingly, the conditions in Expressions (18) and (19) mean that, in a case where the target image group with noise added to the candidate image group C is denoted as ˜C, the rank of image IR(q, C)ⱼ in the target image group ˜C in a case where the input image is q varies only at most α with respect to the rank j of image IR(q, C)ⱼ in a case where the input image is q. Note that since the upper limit/lower limit calculation portion 206 of the robustness verification device 200 uses the upper and lower limits of d(f(q), f(c+δ)), according to the definition of α-robustness verification, there is a possibility that inputs which would originally be verified may be deemed as not verified in the robustness verification device 200.

As with the robustness verification device 100, the rank verification portion 208 of the robustness verification device 200 may include a rank calculation portion 210. In this case, the rank calculation portion 210 outputs the input “j” to the robustness verification device 200 as it is. “j” is Rank(q, IR(q, C)ⱼ, C), which is the rank of image IR(q, C)ⱼ in terms of similarity with input image q in a case where no noise is added to candidate image group C.

Next, the operation of the robustness verification device 200 shall be described with reference to FIG. 6. FIG. 6 is a flowchart showing an example of the processing procedure in which the robustness verification device 200 performs α-robustness verification.

First, the robustness verification device 200 receives as input input image q∈χ, which is the query candidate image group C={cᵢ∈χ}(i=1 to N), feature amount extractor f, perturbation size e, parameter α, and rank j (Step S201).

Next, the similar image identification portion 202 identifies the image IR(q, C)ⱼ that is the j-th most similar to the input image q in the candidate image group C. Specifically, the similar image identification portion 202 uses the feature amount extractor f to calculate the feature amounts f(q), f(cᵢ) (i=1 to N) of the input image q and each candidate image cᵢ∈C, and calculates the Euclidean distance dist (f(q), f(cᵢ)) between the feature amounts f(q) and each f(cᵢ). Then, the similar image identification portion 202 identifies the image with the j-th smallest distance from the input image q as IR(q, C), (Step S202).

Next, for each target image c in the candidate image group C, the upper limit/lower limit calculation portion 206 calculates the upper limit d_{c}(f(q), f(c)) and lower limit _d_{c}(f(q), f(c)) of d(f(q), f(c+δ)) satisfying Expression (15) for any δ satisfying Expression (14) (Step S203).

Next, the rank counting portion 212 of the rank verification portion 208 calculates the right side of Expression (18). That is, the rank counting portion 212 counts “1[ d_{c}(f(q), f(c))<d_{c}(f(q), f(IR(q, C)ⱼ))]” for all elements c except IR(q, C)ⱼ from the candidate image group C in Expression (18), and then adds 1 to the count. The rank counting portion 212 also calculates the left side of Expression (19). That is, the rank counting portion 212 counts “1[ d_{c}(f(q), f(IR(q, C)ⱼ))<_d_{c}(f(q), f(c))]” for all elements c except IR(q, C)ⱼ from the candidate image group C in Expression (19), and subtracts the counted value from the element number N of C (Step S204).

Next, the rank verification portion 208 verifies whether the value of the right side of the calculated Expression (18) is equal to or greater than “j−α”, and the value of the left side of the calculated Expression (19) is equal to or less than “j+α”. If the condition holds, the rank verification portion 208 outputs that α-robustness is verified, and if the condition does not hold, it outputs that α-robustness is not verified (Step S205).

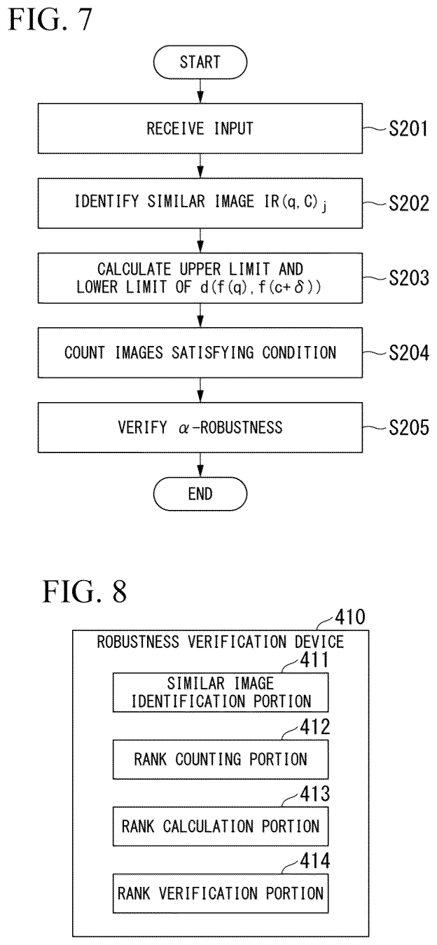

After Step S205, the robustness verification device 200 ends the process in FIG. 7.

The robustness verification device 200 may not perform α-robustness verification only for a specific rank j, and may perform α-robustness verification for multiple j, or for all j with 1≤j≤N.

As explained above, the similar image identification portion 202 identifies similar images IR(q, C)ⱼ. The upper limit/lower limit calculation portion 206 calculates the upper and lower limits of d(f(q), f(c+δ)) for each target image. The rank verification portion 208 verifies the conditions in Expressions (18) and (19).

Thereby, the robustness verification device 200 can perform α-robustness verification, i.e., can verify, in a case where the target image group with noise added to the candidate image group C is denoted as ˜C, that the rank of image IR(q, C)ⱼ in the target image group ˜C in a case where the input image is q varies only at most α with respect to the rank j of image IR(q, C)ⱼ in a case where the input image is q. That is, the robustness verification device 200 can verify the degree of influence on search results in content-based image retrieval in a case where an adversarial example to which adversarial perturbation is added is applied.

For each target image c in the candidate image group C, the upper limit/lower limit calculation portion 206 calculates the upper limit d_{c}(f(q), f(c)) and lower limit _d_{c}(f(q), f(c)) of d(f(q), f(c+δ)) for any δ satisfying Expression (14). The robustness verification device 200 then uses these upper and lower limits to perform (α, B)-robustness verification.

This allows the robustness verification device 200 to perform α-robustness verification with a small amount of computation (practical computation time).

The rank verification portion 208 also uses the parameter α to determine the amount of variation in rank that is acceptable.

This allows the robustness verification device 200 to adjust the accuracy of the verification, such as the larger α is, the easier it is for α-robustness verification to be performed.

### Third Example Embodiment

FIG. 8 is diagram showing an example of the configuration of the robustness verification device according to the third example embodiment. In the configuration shown in FIG. 8, the robustness verification device 410 includes a similar image identification portion 411, a rank counting portion 412, a rank calculation portion 413, and a rank verification portion 414.

In such a configuration, the similar image identification portion 411 identifies similar images in the candidate image group that have a predetermined rank in similarity to the input image using the similarity between the features by the feature amount extractor. The rank counting portion 412 counts the rank of similar images to the input image in the candidate image group in a case where adversarial perturbation is applied to the image. The rank counting portion 413 calculates the rank of similar images to the input image in the candidate image group in a case where adversarial perturbation is not applied to the image. The rank verification portion 414 verifies whether the rank of similar images counted by the rank counting portion 412 is within a predetermined range including the rank of similar images calculated by the rank calculation portion 413.

The similar image identification portion 411 corresponds to an example of a similar image identification means. The rank counting portion 412 corresponds to an example of a rank counting means. The rank calculation portion 413 corresponds to an example of a rank calculation means. The rank verification portion 414 corresponds to an example of a rank verification means.

The robustness verification device 410 can verify α-robustness, i.e., that the rank of a similar image with respect to the input image in the target image group to which noise is added varies only at most α relative to the rank of a similar image to the input image in the candidate image group. That is, the robustness verification device 410 can verify the degree of influence on search results in content-based image retrieval in a case where an adversarial example to which adversarial perturbation is added is applied.

### Fourth Example Embodiment

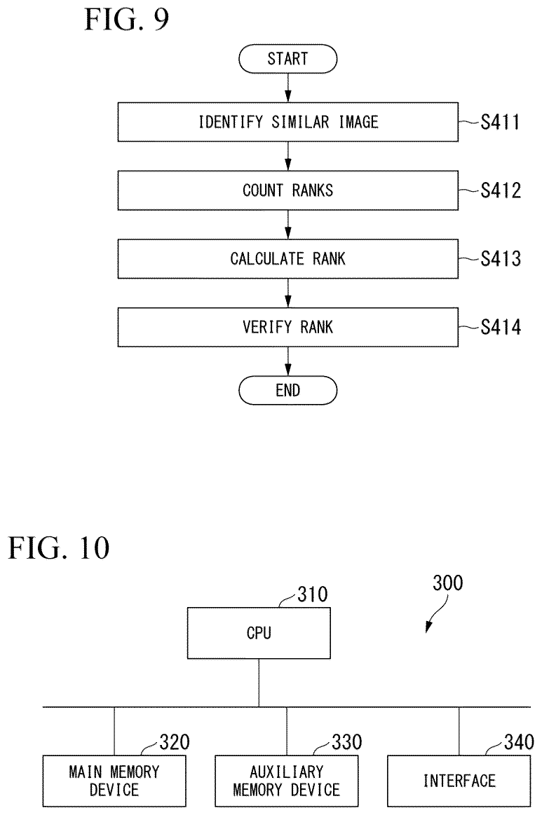

FIG. 9 is diagram showing an example of the processing procedure in the robustness verification method according to the fourth example embodiment. The robustness verification method shown in FIG. 9 includes identifying similar images (Step S411), counting ranks (Step S412), calculating a rank (Step S413), and verifying a rank (Step S414).

In identifying similar images (Step S411), the similarity between features by the feature amount extractor is used to identify a similar image in the candidate image group having a predetermined rank in similarity to the input image. In counting the rank (Step S412), the ranks of similar images relative to the input image in the candidate image group are counted in a case where the image is subjected to adversarial perturbation. In calculating the rank (Step S413), the rank of similar images relative to the input image in the candidate image group is calculated in a case where adversarial perturbation is not applied to the image. In verifying the rank (Step S414), it is verified whether the rank of similar images counted in a case where the image is subjected to adversarial perturbation is within a predetermined range including the rank of similar images calculated in a case where the adversarial perturbation is not applied to the image.

According to the robustness verification method shown in FIG. 9, it is possible to verify α-robustness, i.e., that the rank of a similar image with respect to the input image in the target image group to which noise is added varies only at most α relative to the rank of a similar image to the input image in the candidate image group. That is, the robustness verification method shown in FIG. 9 can verify the degree of influence on search results in content-based image retrieval in a case where an adversarial example to which adversarial perturbation is added is applied.

FIG. 10 is a schematic block diagram showing the configuration of a computer according to at least one example embodiment.

In the configuration shown in FIG. 10, a computer 300 includes a CPU (Central Processing Unit) 310, a main memory device 320, an auxiliary memory device 330, and an interface 340.

Any one or more of the above robustness verification devices 100, 200, and 610 may be implemented in the computer 300. In that case, the operations of each of the above-mentioned processing portions are stored in the auxiliary memory device 330 in the form of a program. The CPU 310 reads the program from the auxiliary memory device 330, expands it in the main memory device 320, and executes the aforementioned processing according to the program. The CPU 310 also reserves a memory area in the main memory device 320 corresponding to each of the above-mentioned memory portions according to the program. Communication between each device and other devices is executed by the interface 340, which has a communication function and communicates according to the control of the CPU 310.

In a case where the robustness verification device 100 is implemented in the computer 300, the operations of the similar image identification portion 102, the comparison target image calculation portion 104, the upper limit/lower limit calculation portion 106, and the rank verification portion 108 are stored in auxiliary memory device 330 in program form. The CPU 310 reads the program from the auxiliary memory device 330, expands it in the main memory device 320, and executes the aforementioned processing according to the program.

The CPU 310 also allocates a memory area in the main memory device 320 for the robustness verification device 100 to perform processing according to the program. The output of the (α, β)-robustness verification of the robustness verification device 100 is executed by the interface 340, which has output functions such as communication or display functions and performs output processing according to the control of the CPU 310. Communication between the robustness verification device 100 and other devices is executed by the interface 340, which has communication functions and operates according to the control of the CPU 310. The interaction between the robustness verification device 100 and the user is executed by the interface 340, which has a display and input device and operates according to the control of the CPU 310.

In a case where the robustness verification device 200 is implemented in the computer 300, the operations of the similar image identification portion 202, upper limit/lower limit calculation portion 206, and the rank verification portion 208 are stored in the auxiliary memory device 330 in the form of programs. The CPU 310 reads the program from the auxiliary memory device 330, expands it in the main memory device 320, and executes the aforementioned processing according to the program.

The CPU 310 also allocates a memory area in the main memory device 320 for the robustness verification device 200 to perform processing according to the program. The output of the α-robustness verification of the robustness verification device 200 is executed by the interface 340, which has output functions such as communication or display functions and performs output processing according to the control of the CPU 310. Communication between the robustness verification device 200 and other devices is executed by the interface 340, which has communication functions and operates according to the control of the CPU 310. The interaction between the robustness verification device 200 and the user is executed by the interface 340, which has a display and input device and operates according to the control of the CPU 310.

In a case where the robustness verification device 610 is implemented in the computer 300, the operations of the robustness verification device 410, the similar image identification portion 411, the rank counting portion 412, the rank calculation portion 413, and the rank verification portion 414 are stored in the auxiliary memory device 330 in the form of programs. The CPU 310 reads the program from the auxiliary memory device 330, expands it in the main memory device 320, and executes the aforementioned processing according to the program.

The CPU 310 also allocates a memory area in the main memory device 320 for the robustness verification device 610 to perform processing according to the program. The output of the robustness verification device 610 is executed by the interface 340, which has output functions such as communication or display functions and performs output processing according to the control of the CPU 310. Communication between the robustness verification device 610 and other devices is executed by the interface 340, which has communication functions and operates according to the control of the CPU 310. The interaction between the robustness verification device 610 and the user is executed by the interface 340, which has a display and input device and operates according to the control of the CPU 310.

A program for executing all or part of the processes performed by the robustness verification devices 100, 200, and 610 may be recorded on a computer-readable recording medium, and the computer system may read and execute the program recorded on this recording medium to perform the processes of each part. The term “computer system” here shall include an operating system and hardware such as peripherals.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with programs already recorded in the computer system.

While preferred example embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

### INDUSTRIAL APPLICABILITY

Example embodiments of the present invention may be applied to a robustness verification device, a robustness verification method, a program, and recording medium.

### DESCRIPTION OF REFERENCE SIGNS

100, 200 Robustness verification device
102, 202 Similar image identification portion
104 Comparison target image calculation portion
106, 206 Upper limit/lower limit calculation portion
108, 208 Rank verification portion
110 (210) Rank calculation portion
112, 212 Rank counting portion
900 Content-based image retrieval device
902 Image storage portion
904 Feature amount extraction portion
906 Rank calculation portion

1. A robustness verification device comprising:
at least one memory configured to store instructions; and
at least one processor configured to execute the instructions to:
use the similarity between feature amounts obtained by extracting a feature amount to identify a similar image having a predetermined rank of similarity with respect to an input image within a candidate image group;
count the rank of the similar image with respect to the input image in the candidate image group in a case where adversarial perturbation is applied to the image;
calculate the rank of the similar image with respect to the input image in the candidate image group in a case where adversarial perturbation is not applied to the image; and
verify whether or not the counted rank of the similar image is within a predetermined range that includes the calculated rank of the similar image.

2. The robustness verification device according to claim 1, wherein the at least one processor is configured to execute the instructions to:
calculate the upper limit and lower limit of the similarity between the feature amounts obtained by extracting the feature amount between the input image and the images of the candidate image group in a case where adversarial perturbation is applied to the image, and
count the rank of the similar image with respect to the input image in the candidate image group in a case where adversarial perturbation is applied to the image, using the calculated upper limit and the calculated lower limit.

3. The robustness verification device according to claim 2, wherein the adversarial perturbation is applied to the input image.

4. The robustness verification device according to claim 3, wherein the at least one processor is configured to execute the instructions to:
include the similar image and an image in which the similarity between feature amounts obtained by extracting the feature amount with the similar image in an image of the candidate image group is equal to or greater than a predetermined value in a target image group,
use the target image group as the candidate image group, and
use the target image group as the candidate image group.

5. The robustness verification device according to claim 2, wherein the adversarial perturbation is applied to one or more images in the candidate image group.

6. The robustness verification device according to claim 5, wherein the at least one processor is configured to execute the instructions to: calculate the rank of the similar image from the candidate image group to which the adversarial perturbation is applied; and
make the rank of the similar image the predetermined rank.

7. The robustness verification device according to claim 2, wherein the image is one in which the magnitude of the adversarial perturbation is equal to or less than a predetermined value in the infinity norm.

8. The robustness verification device according to claim 7, wherein the at least one processor is configured to execute the instructions to calculate the upper limit and the lower limit on the basis of an upper limit and lower limit of each element of the feature amounts obtained by extracting the feature amount an image to which adversarial perturbation is applied.

9. The robustness verification device according to claim 1, wherein the extracting the feature amount includes extracting a feature amount using a deep learning model.

10. The robustness verification device according to claim 1, wherein the extracting the feature amount includes extracting a feature amount using using Deep Metric Learning.

11. A robustness verification method comprising:
using the similarity between feature amounts obtained by extracting a feature amount to identify a similar image having a predetermined rank of similarity with respect to an input image within a candidate image group;
counting the rank of the similar image with respect to the input image in the candidate image group in a case where adversarial perturbation is applied to the image;
calculating the rank of the similar image with respect to the input image in the candidate image group in a case where adversarial perturbation is not applied to the image; and
verifying whether or not the rank of the similar image counted in a case where adversarial perturbation is applied to an image is within a predetermined range that includes the rank of the similar image calculated in a case where adversarial perturbation is not applied to an image.

12. A non-transitory recording medium that records a program for causing a computer to execute:
using the similarity between feature amounts obtained by extracting a feature amount to identify a similar image having a predetermined rank of similarity with respect to an input image within a candidate image group;
counting the rank of the similar image with respect to the input image in the candidate image group in a case where adversarial perturbation is applied to the image;
calculating the rank of the similar image with respect to the input image in the candidate image group in a case where adversarial perturbation is not applied to the image; and
verifying whether or not the rank of the similar image counted in a case where adversarial perturbation is applied to an image is within a predetermined range that includes the rank of the similar image calculated in a case where adversarial perturbation is not applied to an image.
